(19) United States
(12) Patent Application Publication
(10) Pub. No.: US 2026/0073155 A1
(43) Pub. Date: Mar. 12, 2026

(54) METHOD, DEVICE, AND COMPUTER PROGRAM FOR PROVIDING PROMPT FOR GENERATIVE AI-BASED DOCUMENT WRITING

(71) Applicant: SAMSUNG SDS CO., LTD., Seoul (KR)

(72) Inventor: Seunghwan KIM, Seoul (KR)

(73) Assignee: SAMSUNG SDS CO., LTD., Seoul (KR)

(21) Appl. No.: 19/277,918

(22) Filed: Jul. 23, 2025

(30) Foreign Application Priority Data
Sep. 12, 2024 (KR) 10-2024-0124986
Oct. 29, 2024 (KR) 10-2024-0149741

(51) Int. Cl. G06F 40/40

(52) U.S. Cl. CPC G06F 40/40

(57) ABSTRACT

The present disclosure relates to a method, a device, and a computer program for providing a prompt for generative AI-based document writing. The present disclosure proposes a method for providing a prompt for generative AI-based document writing, the method including: receiving a command to execute a document writing application; determining a prompt to be provided from among a static prompt and a dynamic prompt; displaying, on a screen, the prompt to be provided; and, when the prompt to be provided is selected, receiving a document, generated based on the prompt to be provided, from an LLM.

### CROSS-REFERENCE TO RELATED APPLICATION(S)

This application is based on and claims priority under 35 U.S.C. 119 to Korean Patent Applications No. 10-2024-0124986, filed on Sep. 12, 2024, and No. 10-2024-0149741, filed on Oct. 29, 2024, in the Korean Intellectual Property Office, the disclosure of which is herein incorporated by reference in its entirety.

### BACKGROUND OF THE INVENTION

### 1. Field of the Invention

The present disclosure relates to a method, a device, and a computer program for providing a prompt for generative AI-based document writing and, more specifically, to a method, a device, and a computer program for providing a user-customized prompt during AI-based document writing.

### 2. Description of the Prior Art

In the case of conventional AI-based document writing prompts, particularly prompts for drafting and replying emails with Copilot, only fixed guide prompts are provided. As a result, LLM responses were monotonous, and when there was no prompt suitable for a user's purpose, the user had to write a prompt for a new case on his/her own. Therefore, when a user's prompt writing ability was insufficient, it took a lot of time to write prompts, and it was necessary to go through multiple utterances to obtain a desired response result, causing considerable inconvenience. Additionally, even when the user succeeds in obtaining the desired LLM response, there is no function to store or manage used prompts, thereby necessitating the user to manually record the prompts in a separate storage for future reuse. Furthermore, since provided user guide prompts were hard-coded in the source code, additional system update work was required to add or modify the guide prompts.

In other words, despite the need for a solution that provides and manages personalized prompts for AI-based document writing, no appropriate solution has yet been proposed.

### SUMMARY OF THE INVENTION

The present disclosure has been made to solve the above-described problems of the prior art, and an aspect of the present disclosure is to provide a method, a device, and a computer program for providing a prompt for generative AI-based document writing.

Furthermore, an aspect to the present disclosure is to provide a method, a device, and a computer program for providing a user-customized prompt during generative AI-based document writing.

Furthermore, an aspect of the present disclosure is to provide a method, a device, and a computer program for providing an appropriate prompt utilization method and a recommended prompt to a user when writing drafts and replies in an email service using generative AI.

Furthermore, an aspect of the present disclosure is to provide a method, a device, and a computer program for providing a generative AI-based document writing prompt that can provide the convenience of prompt writing and improve the quality of LLM responses, through a user-customized prompt environment configuration that enables management of individual prompts.

Furthermore, an aspect of the present disclosure is to provide a method, a device, and a computer program for providing a prompt for generative AI-based document writing that enables the sharing and utilization of a high-quality prompt through prompt configuration management functions for individuals, companies, and departments.

Furthermore, an aspect of the present disclosure is to provide a method, a device, and a computer program for providing a prompt for generative AI-based document writing, wherein, unlike an existing fixed prompt provision method, user patterns are analyzed using AI to provide a personalized prompt (e.g., a static prompt or a dynamic prompt), thereby improving the convenience of prompt writing and prompt usability, and enabling the provision of a high-quality prompt.

The technical problems addressed by the present disclosure are not limited to those mentioned above, and other technical problems not mentioned herein may be clearly understood by those skilled in the art from the description of the present specification.

According to a first aspect of the present disclosure, a method for providing a prompt for generative AI-based document writing may include: receiving a command to execute a document writing application; determining a prompt to be provided from among a static prompt and a dynamic prompt; displaying, on a screen, the prompt to be provided; and, in case that the prompt to be provided is selected, receiving a document, generated based on the prompt to be provided, from an LLM.

Furthermore, the method may further include, in case that the static prompt is determined as the prompt to be provided in the determining of the prompt to be provided, checking whether there is a configuration for the static prompt, exposing a configured prompt chip on the screen in case that there is a configuration, and exposing a default prompt chip on the screen in case that there is no configuration.

Furthermore, the method may further include, in case that the static prompt is determined as the prompt to be provided in the determining of the prompt to be provided, determining whether to add personal content information to the static prompt.

In case that the dynamic prompt is determined as the prompt to be provided in the determining of the prompt to be provided, at least one of an AI-based recommended prompt and a rank-based recommended prompt may be displayed on the screen in the displaying of the prompt to be provided on the screen.

The AI-based recommended prompt may be generated based on at least one of content information and a prompt call history of a user of the document writing application.

The rank-based recommended prompt may be generated based on information including the prompt call history of the user of the document writing application.

Furthermore, the method may further include: checking whether a prompt category selection for the dynamic prompt is input; exposing and displaying only at least one selected prompt category in case that the prompt category selection is input; and exposing and displaying all prompt categories in case that the prompt category selection is not input.

In case that the prompt to be provided is selected, information about the prompt to be provided may be stored as prompt history information.

The prompt history information may be used when generating an AI-based recommended prompt or a rank-based recommended prompt.

A second aspect of the present disclosure may relate to a computer program stored on a medium in order to perform, in combination with hardware, a method for providing a prompt for generative AI-based document writing.

A third aspect of the present disclosure may relate to a device for providing a prompt for generative AI-based document writing, the device including a processor, wherein the processor is configured to perform: receiving a command to execute a document writing application; determining a prompt to be provided from among a static prompt and a dynamic prompt; displaying, on a screen, the prompt to be provided; and in case that the prompt to be provided is selected, receiving a document, generated based on the prompt to be provided, from an LLM.

Furthermore, the processor may be configured to further perform, in case that the static prompt is determined as the prompt to be provided in the determining of the prompt to be provided, checking whether there is a configuration for the static prompt, exposing a configured prompt chip on the screen in case that there is a configuration, and exposing a default prompt chip on the screen in case that there is no configuration.

Furthermore, the processor may be configured to further perform, in case that the static prompt is determined as the prompt to be provided in the determining of the prompt to be provided, determining whether to add personal content information to the static prompt.

In case that the dynamic prompt is determined as the prompt to be provided in the determining of the prompt to be provided, at least one of an AI-based recommended prompt and a rank-based recommended prompt may be displayed on the screen in the displaying of the prompt to be provided on the screen.

The AI-based recommended prompt may be generated based on at least one of content information and a prompt call history of a user of the document writing application.

The rank-based recommended prompt may be generated based on information including the prompt call history of the user of the document writing application.

Furthermore, the processor may be configured to further perform: checking whether a prompt category selection for the dynamic prompt is input; exposing and displaying only at least one selected prompt category in case that the prompt category selection is input; and exposing and displaying all prompt categories in case that the prompt category selection is not input.

In case that the prompt to be provided is selected, information about the prompt to be provided may be stored as prompt history information.

The prompt history information may be used when generating an AI-based recommended prompt or a rank-based recommended prompt.

Therefore, according to an embodiment of the present disclosure, the method, the device, and the computer program for providing a prompt for generative AI-based document writing may provide a user-customized prompt during generative AI-based document writing.

Furthermore, according to an embodiment of the present disclosure, the method, the device, and the computer program for providing a prompt for generative AI-based document writing may provide an appropriate prompt utilization method and a recommended prompt to a user when writing drafts and replies in an email service using generative AI.

Furthermore, according to an embodiment of the present disclosure, the method, the device, and the computer program for providing a prompt for generative AI-based document writing may provide the convenience of prompt writing and improve the quality of LLM responses, through a user-customized prompt environment configuration that enables management of individual prompts.

Furthermore, according to an embodiment of the present disclosure, the method, the device, and the computer program for providing a prompt for generative AI-based document writing may provide a prompt for generative AI-based document writing that enables the sharing and utilization of a high-quality prompt through prompt configuration management functions for individuals, companies, and departments.

Furthermore, according to an embodiment of the present disclosure, the method, the device, and the computer program for providing a prompt for generative AI-based document writing may analyze user patterns by using AI to provide a personalized prompt (e.g., a static prompt or a dynamic prompt), thereby improving the convenience of prompt writing and prompt usability, and enabling the provision of a high-quality prompt.

The effects obtainable from the present disclosure are not limited to those mentioned above, and other effects not mentioned herein will be clearly understood by those skilled in the art, to which the present disclosure belongs, from the description of the present specification.

### BRIEF DESCRIPTION OF THE DRAWINGS

The accompanying drawings, which are included as part of the detailed description in order to help understand the present disclosure, provide an embodiment of the present disclosure and illustrate the technical idea of the present disclosure along with the detailed description.

FIG. 1 is a flowchart illustrating a method for providing a static prompt for generative AI-based document writing according to an embodiment of the present disclosure;

FIG. 2A AND FIG. 2B are a flowchart for providing a static prompt for generative AI-based document writing according to an embodiment of the present disclosure;

FIG. 3 illustrates the configuration of a static prompt for generative AI-based document writing according to an embodiment of the present disclosure;

FIG. 4 illustrates a screen display of a static prompt for generative AI-based document writing according to an embodiment of the present disclosure;

FIG. 5 illustrates the display of my content list on a screen according to an embodiment of the present disclosure;

FIG. 6 is a flowchart illustrating a method for providing a dynamic prompt for generative AI-based document writing according to an embodiment of the present disclosure;

FIG. 7A AND FIG. 7B are a flowchart for providing a dynamic prompt for generative AI-based document writing according to an embodiment of the present disclosure.

FIG. 8 illustrates a screen display of AI-based dynamic prompt recommendation for generative AI-based document writing according to an embodiment of the present disclosure;

FIG. 9 illustrates a screen display of rank-based dynamic prompt recommendation for generative AI-based document writing according to an embodiment of the present disclosure; and

FIG. 10 illustrates a device to which the proposed method of the present disclosure can be applied.

### DETAILED DESCRIPTION OF THE EXEMPLARY EMBODIMENTS

Hereinafter, the embodiments disclosed in the present specification will be described in detail with reference to the accompanying drawings. The aspects, specific advantages, and novel features of the present disclosure will become apparent from the following detailed description and preferred embodiments associated with the accompanying drawings.

The terms and words used in the present specification and in the claims are defined appropriately by the inventor to best describe the disclosure and should be construed as meanings or concepts consistent with the technical idea of the present disclosure. The terms and words are merely provided to describe embodiments and should not be construed as limiting the present disclosure.

In assigning reference numerals to components, identical or similar components are assigned the same reference numerals regardless of the reference numerals, and redundant descriptions thereof will be omitted. The suffixes “module” and “unit” for components, used in the following description, are given or used interchangeably for ease of drafting the specification, do not inherently have distinct meanings or roles, and may refer to either software or hardware components.

In describing the components of the present disclosure, when a component is expressed in the singular form, it is to be understood that the component also includes the plural form unless otherwise specifically stated. Furthermore, the terms “first,” “second,” and the like are used to distinguish one component from another, and the components are not limited by the terms. Furthermore, when a component is connected to another component, it is intended that another component may be connected between the component and the other component.

Furthermore, in describing embodiments disclosed in the present specification, detailed descriptions of related well-known technologies may be omitted when the detailed descriptions are considered to obscure the essence of the embodiments disclosed in the present specification. Furthermore, the accompanying drawings are provided only to facilitate understanding of the embodiments disclosed in the present specification, and it is to be understood that the technical idea disclosed in the present specification is not limited by the accompanying drawings and include all modifications, equivalents, or substitutions that are within the scope of the idea and technology of the present disclosure.

Hereinafter, exemplary embodiments of a method, a device, and a computer program for providing a user-customized prompt during generative AI-based document writing according to the present disclosure will be described in detail with reference to the accompanying drawings.

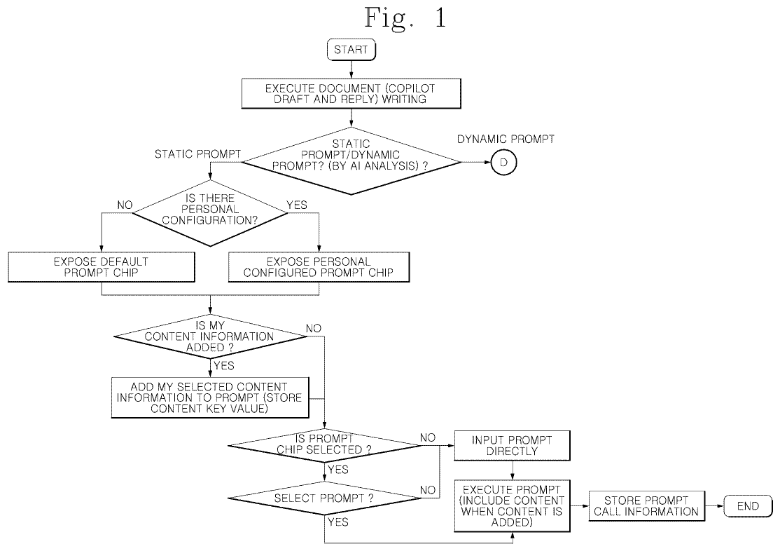

FIG. 1 is a flowchart illustrating a method for providing a static prompt for generative AI-based document writing according to an embodiment of the present disclosure.

When a document writing application such as Copilot Draft or Reply is executed (i.e., when a command to execute the document writing application is received), an artificial intelligence (AI) module determines whether to provide a static prompt or a dynamic prompt to an application user. The static prompt to be selected by the AI module does not refer to a single specific prompt, but to a group including at least one static prompt. Also, the dynamic prompt to be selected by the AI module does not refer to a single specific prompt, but to a group including at least one Dynamic prompt. That is, the AI module's determination to provide a static prompt means that the AI module has selected a method for providing a static prompt to the document writing application user. The AI module's determination to provide dynamic prompts means that the AI module has selected a method for providing a dynamic prompt to the document writing application user. This determination may be made based on the AI module's artificial intelligence analysis of the document writing application user's prompt usage history or prompt usage configuration. When it is determined, through the artificial intelligence analysis, to provide a static prompt, a static prompt popup is exposed on a screen, and a prompt for the application user is called (a personal prompt is called). The static prompt refers to a prompt added or configured by a document writing application author or a document writing application administrator. The dynamic prompt refers to an AI-based recommended prompt, generated based on the document writing application user's prompt call history and user content information within a system, such as emails or approvals sent and received by the user, or a rank-based recommended prompt (a prompt with a higher score is recommended) generated based on the document writing application user's prompt call history.

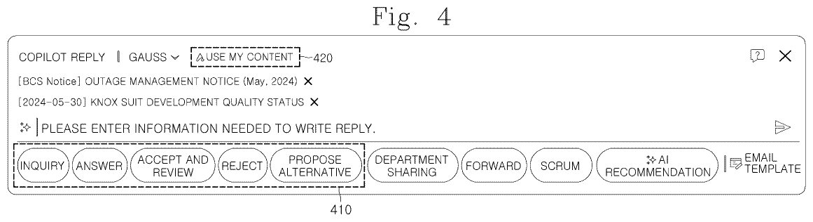

Then, whether there is a personal configuration for the prompt is checked. When there is a personal configuration, a configured prompt chip is exposed. When there is no personal configuration, a default prompt chip is exposed. The chip refers to an on-screen display portion indicating the category of a document to be written, and indicates a dotted box display portion 410 in FIG. 4. For example, in the screen embodiment illustrated in FIG. 4, if default prompt chips are “Inquiry,” “Answer,” “Accept and Review,” “Reject,” and “Propose Alternative,” and if prompt chips configured by the application user are “Inquiry,” and “Answer,” the prompt chips “inquiry” and “answer” are exposed when there is an application user configuration, and the prompt chips “Inquiry,” “Answer,” “Accept and Review,” “Reject,” and “Propose Alternative” are all exposed when there is no application user configuration.

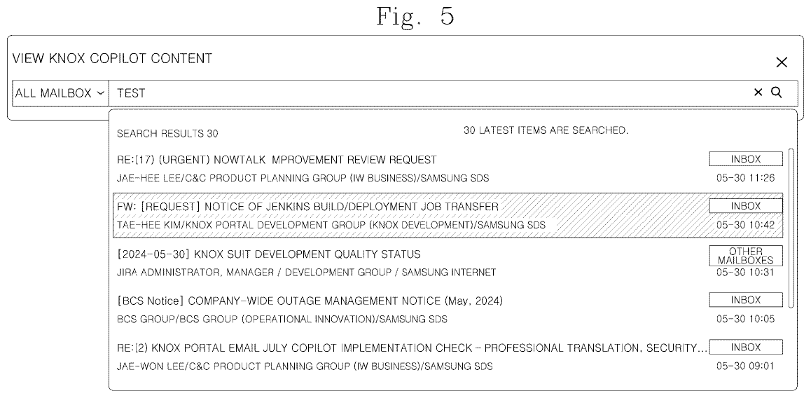

Then, whether to add my content information (personal content information) to the prompt is selected. When selection of adding my content information is made, my selected content information is added to the prompt. This addition is made in the form of storing a content key value, and later, the content key value is transmitted as an input to an LLM along with the prompt, enabling the LLM to generate a document based on this input. Here, my content information refers to emails, approvals, posts, etc., written by the application user. In the screen embodiment illustrated in FIG. 4, when a “My Content Utilization 420” area is selected, the addition of my content information is selected, and then a screen embodiment illustrated in FIG. 5 is displayed. In the screen in FIG. 5, my content list is displayed, and when any content is selected from the list, the content information is added to the prompt.

Then, when a prompt chip is selected from the exposed prompt chips, a prompt corresponding to the prompt chip is displayed on the screen. When the prompt displayed on the screen is selected, the prompt is executed (called), and a response result (a generated document) is received from the LLM. In this case, when a prompt is selected and executed (called), information about the called prompt is stored as prompt history information. The prompt history information may be used as statistical information, and may later be used for prompt recommendation (AI-based prompt recommendation or rank-based prompt recommendation). Additionally, a prompt may be directly input without selecting an exposed prompt chip or a prompt displayed on the screen. The input prompt is called, and a response result (a generated document) is received from the LLM. In this case, when a prompt is input and executed (called), information about the called input prompt is also stored as prompt history information. The prompt history information may be used as statistical information, and may later be used for prompt recommendation (AI-based prompt recommendation or rank-based prompt recommendation).

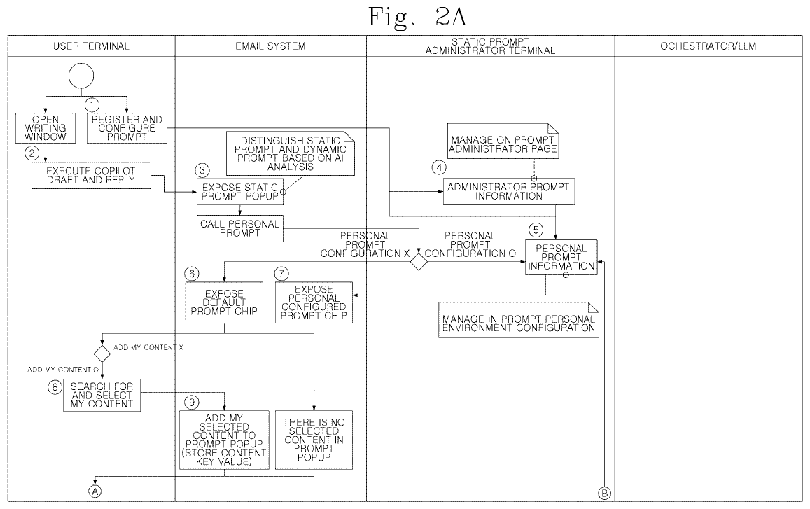

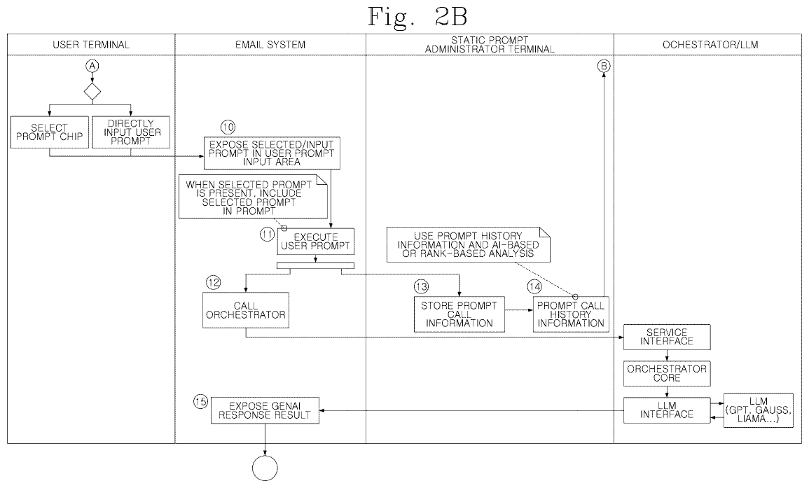

FIG. 2 (FIGS. 2A and 2B) illustrates a flowchart for providing a static prompt for generative AI-based document writing according to an embodiment of the present disclosure.

First, the registration and configuration of a prompt used for drafting and reply to emails are initiated (1). When a document writing application such as Copilot Draft or Reply is executed (2), an AI module determines whether to provide a static prompt or a dynamic prompt to an application user. This determination may be made based on the AI module's artificial intelligence analysis of the document writing application user's prompt usage history or prompt usage configuration. When it is determined, through the artificial intelligence analysis, to provide a static prompt, a static prompt popup is exposed on a screen, and a prompt for the application user is called (a personal prompt is called) (3).

To register and configure the prompt used for drafting and reply to an email, a prompt administrator terminal adds (registers) and configures the prompt on a prompt administrator page (4). In this case, the prompt administrator terminal designates a prompt disclosure scope, such as “all,” “company,” “department,” or “individual,” according to the intended use, and configures and manages whether to perform exposure in which a prompt with an issue can be blocked.

Then, whether there is a personal configuration for the prompt is checked. When there is a personal configuration, a configured prompt chip is exposed (7). When there is no personal configuration, a default prompt chip is exposed (6). The personal configuration for the prompt refers to adding, modifying, storing, and managing a prompt for each person, and stores category items to be exposed on the chip and a prompt content displayed when the chip is selected (5, an existing call prompt may be designated by identifying the prompt call history information). The chip refers to an on-screen display portion indicating the category of a document to be written, and indicates a dotted box display portion 410 in FIG. 4. For example, in the screen embodiment illustrated in FIG. 4, if default prompt chips are “Inquiry,” “Answer,” “Accept and Review,” “Reject,” and “Propose Alternative,” and if prompt chips configured by the application user are “Inquiry,” and “Answer,” the prompt chips “inquiry” and “answer” are exposed when there is an application user configuration, and the prompt chips “Inquiry,” “Answer,” “Accept and Review,” “Reject,” and “Propose Alternative” are all exposed when there is no application user configuration.

Then, whether to add my content information to the prompt is selected. When selection of adding my content information is made (8), my selected content information is added to the prompt. This addition is made in the form of storing a content key value, and later, the content key value is transmitted as an input to an LLM along with the prompt, enabling the LLM to generate a document based on this input (9). Here, my content information refers to emails, approvals, posts, etc., written by the application user, and may be transmitted along with the prompt during an LLM call to improve the quality of the LLM's response.

Then, when a prompt chip is selected from the exposed prompt chips, a prompt corresponding to the prompt chip is displayed on the screen (10). When the prompt displayed on the screen is selected, the prompt is executed (called), and a response result (a generated document) is received from the LLM (11, 15). The prompt execution refers to executing an API for writing a draft or response for prompt input information. When my content information is selected, a content key value is transmitted along with my content information during an API call. The input prompt is used to call an orchestrator/LLM through a service interface (12), and exposes the LLM's response result on the screen (15). When a prompt is selected and executed (called), information about the called prompt is stored as prompt history information (13). The prompt history information may be used as statistical information, and may later be used prompt recommendation (AI-based prompt recommendation or rank-based prompt recommendation) (14). Additionally, a prompt may be directly input without selecting an exposed prompt chip or a prompt displayed on the screen (10). The input prompt is called, and a response result (a generated document) is received from the LLM (11, 15). In this case, when a prompt is input and executed (called), information about the called input prompt is also stored as prompt history information. The prompt history information may be used as statistical information, and may later be used for prompt recommendation (AI-based prompt recommendation or rank-based prompt recommendation).

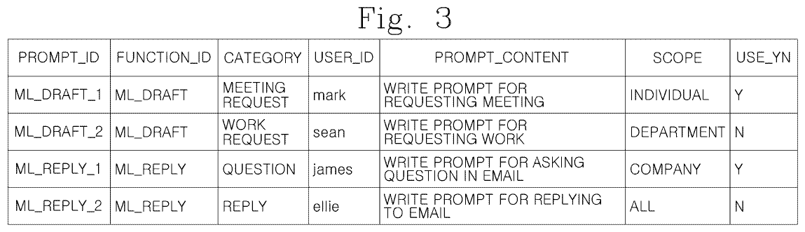

FIG. 3 illustrates the configuration of a static prompt for generative AI-based document writing according to an embodiment of the present disclosure.

For example, a static prompt “Write a meeting request prompt” is assigned a prompt ID of ML_DRAFT_1, the function of the prompt is email drafting (ML_DRAFT), the category of the prompt is “meeting request,” an application user is “Mark,” the sharing configuration is “personal scope,” and the usage approval status is configured to be “approved (Y)”. In other words, for each Static prompt, a prompt ID, a prompt function, a prompt category, an application user, a sharing configuration range, and a usage approval status may be configured.

FIG. 4 illustrates a screen display of a static prompt for generative AI-based document writing according to an embodiment of the present disclosure.

The dotted box display portion 410 in FIG. 4 indicates a chip representing the category of a document to be written. For example, in the screen embodiment illustrated in FIG. 4, default prompt chips are exposed and displayed as “Inquiry,” “Answer,” “Accept and Review,” “Reject,” and “Propose Alternative.”

The dotted box display area 420 in FIG. 4 indicates a “My Content Utilization 420” area for selecting the addition of my content information. When the “My Content Utilization 420” area is selected, the addition of my content information is selected, and then the screen embodiment illustrated in FIG. 5 is displayed. In the screen of FIG. 5, my content list is displayed, and when any content is selected from the list, information about the content is added to the prompt.

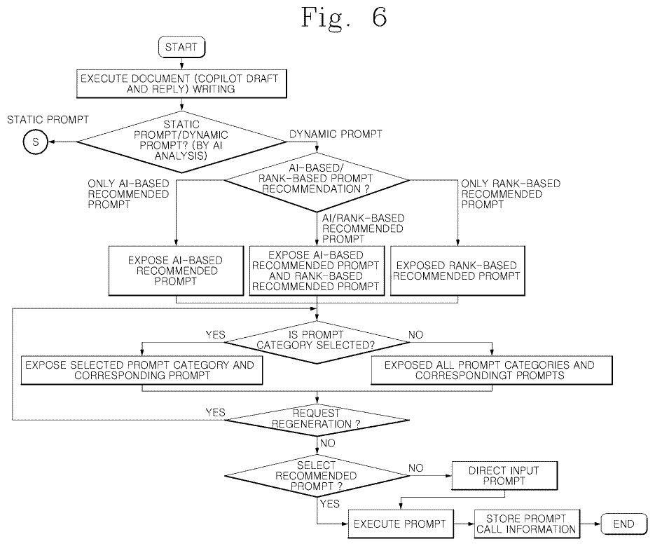

FIG. 6 is a flowchart illustrating a method for providing a dynamic prompt for generative AI-based document writing according to an embodiment of the present disclosure.

When a document writing application such as Copilot Draft or Reply is executed (when a command to execute a document writing application is received), an AI module determines whether to provide a static prompt or a dynamic prompt to an application user (wherein the static prompt refers to a group including at least one static prompt, and the dynamic prompt refers to a group including at least one dynamic prompt). The determination may be made based on the AI module's artificial intelligence analysis of the document writing application user's prompt usage history or prompt usage configuration. When it is determined, through the artificial intelligence analysis, to provide a dynamic prompt, a dynamic prompt popup is exposed on a screen, and a recommended prompt for the application user is called.

Then, prompt recommendation based on AI-based prompt recommendation information or rank-based prompt recommendation information is exposed and displayed on the screen in response to the prompt call. In case of AI-based prompt recommendation and rank-based prompt recommendation, either one may be provided selectively or both may be provided, and depending on the configuration, either one may be provided or both may be provided simultaneously or sequentially. In this case, the AI-based prompt recommendation information may be generated based on the application user's prompt call history and the user's content information within a system, such as emails and approvals sent and received by the user. Furthermore, the rank-based prompt recommendation information is generated based on the application user's prompt call history. For example, the rank (recommendation rank) may be generated based on information such as assigning a weight to the most recent call, decreasing the weight of calls from the same user (or increasing the weight of calls from different users), or feedback functions such as “likes” (score +)/“dislikes” (score −).

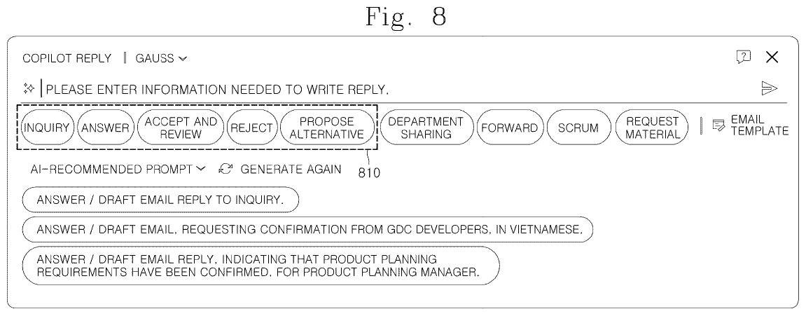

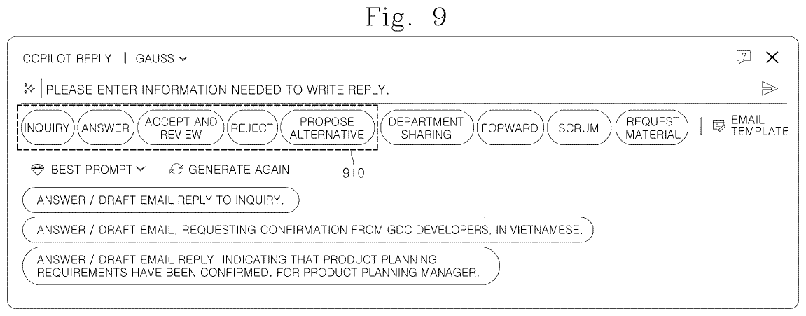

Then, when a prompt category selection is input, only at least one selected prompt category is exposed and displayed. When no prompt category selection is input, all prompt categories are exposed. Here, the category refers to an on-screen display portion indicating the category of a document to be written, which has a meaning very similar to that of a chip, and refers to dotted box display portions 810 and 910 in FIGS. 8 and 9. For example, in screen embodiments illustrated in FIGS. 8 and 9, assuming that “Inquiry,” “Answer,” “Accept and Review,” “Reject,” and “Propose Alternative” represent document categories and that prompt categories selected by the application user are “Inquiry” and “Answer,” only the prompt categories “Inquiry” and “Answer” are exposed on the screen. If there is no prompt category selected by the application user, the prompt categories “Inquiry,” “Answer,” “Accept and Review,” “Reject,” and “Propose Alternative” are all exposed.

Then, when a prompt corresponding to the selected prompt category is exposed and no prompt category is selected, prompts corresponding to all prompt categories are exposed. In other words, when a prompt category is selected from exposed prompt categories, a recommended prompt corresponding to the selected prompt category is displayed on the screen. When the recommended prompt displayed on the screen does not meet the application user's needs, prompt regeneration may be requested, and in response to the regeneration request, an AI-based recommended prompt or a rank-based recommended prompt is regenerated and displayed on the screen. When a recommended prompt displayed on the screen is selected, the recommended prompt is executed (called), and a response result (a generated document) is received from an LLM. In this case, when a recommended prompt is selected and executed (called), information about the called recommended prompt is stored as prompt history information. The prompt history information may be used as statistical information, and may later be used for prompt recommendation (e.g., AI-based prompt recommendation or rank-based prompt recommendation). Additionally, a prompt may be directly input without selecting a prompt from an exposed prompt category or a recommended prompt displayed on the screen. The input prompt is called, and a response result (a generated document) is received from the LLM. In this case, when a prompt is input and executed (called), information about the called prompt is also stored as prompt history information. The prompt history information may be used as statistical data, and may later be used for prompt recommendation (e.g., AI-based prompt recommendation or rank-based prompt recommendation).

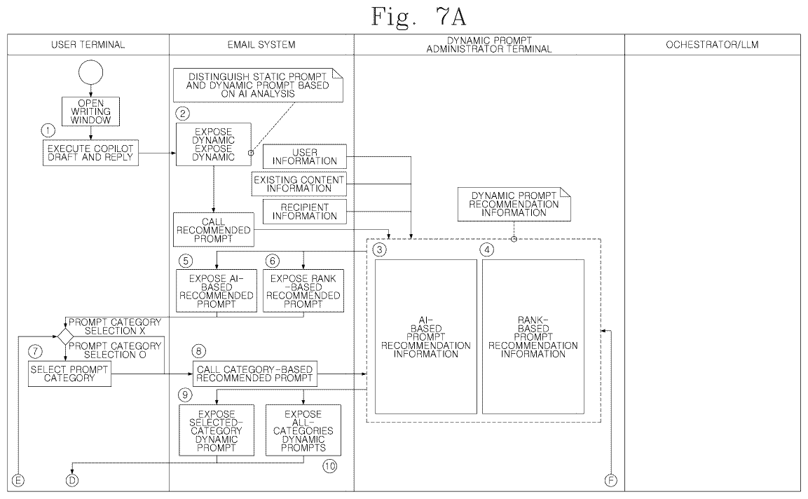

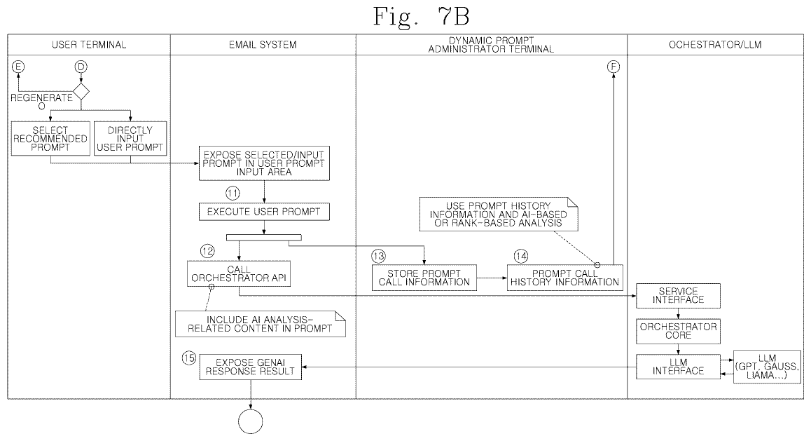

FIG. 7 (FIGS. 7A and 7B) illustrates a flowchart for providing a dynamic prompt for generative AI-based document writing according to an embodiment of the present disclosure.

When a document writing application such as Copilot Draft or Reply is executed (1), an AI module determines whether to provide a static prompt or a dynamic prompt to an application user. The determination may be made based on the AI module's artificial intelligence analysis of the document writing application user's prompt usage history or prompt usage configuration. When it is determined, through the artificial intelligence analysis, to provide a dynamic prompt, a dynamic prompt popup is exposed on a screen, and a recommended prompt for the application user is called (2).

Then, prompt recommendation based on AI-based prompt recommendation information or rank-based prompt recommendation information is exposed and displayed on the screen in response to the prompt call. In the case of AI-based prompt recommendation and rank-based prompt recommendation, either one may be provided selectively or both may be provided, and depending on the configuration, either one may be provided or both may be provided simultaneously or sequentially. In this case, the AI-based prompt recommendation information may be generated based on the application user's prompt call history and the user's content information within a system, such as emails and approvals sent and received by the user (3). Furthermore, the rank-based prompt recommendation information is generated based on the application user's prompt call history (4). For example, the rank (recommendation rank) may be generated based on information such as assigning a weight to the most recent call, decreasing the weight of calls from the same user (or increasing the weight of calls from different users), or a feedback function such as “likes” (score +)/“dislikes” (score −). Multiple AI-based recommended prompts may be exposed, regeneration may be requested or a prompt category may be selected to receive a recommendation for a prompt in the desired category, and switching to rank-based recommendation prompts is possible (5). Multiple rank-based recommendation prompts may also be exposed, regeneration may be requested or a prompt category may be selected to receive a recommendation for a prompt in the desired category, and switching to AI-based recommendation prompts is possible (6).

Then, when a prompt category selection is input, only at least one selected prompt category is exposed and displayed. When no prompt category selection is input, all prompt categories are exposed (7). Here, the category refers to an on-screen display portion indicating the category of a document to be written, which has a meaning very similar to that of a chip, and corresponds to the dotted box display portions 810 and 910 illustrated in FIGS. 8 and 9. For example, in screen embodiments illustrated in FIGS. 8 and 9, assuming that “Inquiry,” “Answer,” “Accept and Review,” “Reject,” and “Propose Alternative” represent document categories and that prompt categories selected by the application user are “Inquiry” and “Answer,” only the prompt categories “Inquiry” and “Answer” are exposed on the screen. If there is not prompt category selected by the application user, the prompt categories “Inquiry,” “Answer,” “Accept and Review,” “Reject,” and “Propose Alternative” are all exposed. Then, depending on whether a prompt category selection is made, a prompt recommendation API is called with all categories configured when no prompt is selected, or with a selected category configured when the category is selected (8).

Then, a prompt corresponding to the selected prompt category is exposed, and when no prompt category is selected, prompts corresponding to all prompt categories are exposed (9, 10). In other words, when a prompt category is selected from the exposed prompt categories, a recommended prompt corresponding to the selected prompt category is displayed on the screen. When the recommended prompt displayed on the screen do not meet the application user's needs, prompt regeneration may be requested, and in response to the regeneration request, an AI-based recommended prompt or a rank-based recommended prompt is regenerated and displayed on the screen. When a recommended prompt displayed on the screen is selected, the recommended prompt is executed (called), and a response result (a generated document) is received from an LLM. The prompt execution refers to executing a draft or reply writing API based on prompt input information (11). The input prompt calls an orchestrator/LLM through a service interface (12), and the response result from the LLM is exposed on the screen (15). When a recommended prompt is selected and executed (called), information about the called recommended prompt is stored as prompt history information (13). The prompt history information may be used as statistical information, and may later be used for prompt recommendation (e.g., AI-based prompt recommendation or rank-based prompt recommendation) (14). Furthermore, a prompt may be directly input without selecting an exposed prompt category or a recommended prompt displayed on the screen. The input prompt is called, and a response result (a generated document) is received from the LLM. The prompt execution refers to executing a draft or reply writing API based on prompt input information (11). When a prompt is input and executed (called), information about the called prompt is also stored as prompt history information (13). The prompt history information may be used as statistical information, and may later be used for prompt recommendation (AI-based prompt recommendation or rank-based prompt recommendation) (14).

FIG. 8 illustrates a screen display of AI-based dynamic prompt recommendation for generative AI-based document writing according to an embodiment of the present disclosure.

The dotted box display portion 810 in FIG. 8 indicates a chip representing the category of a document to be written. For example, in the screen embodiment illustrate in FIG. 8, default prompt chips are exposed and displayed as “Inquiry,” “Answer,” “Accept and Review,” “Reject,” and “Propose Alternative.”

An AI-recommended prompt at the bottom of FIG. 8 refer to an AI-based recommended prompt, and when “Generate Again” is selected, another AI-based recommended prompt may be generated and provided.

FIG. 9 illustrates a screen display of rank-based dynamic prompt recommendation for generative AI-based document writing according to an embodiment of the present disclosure.

The dotted box display portion 910 in FIG. 9 indicates a chip representing the category of a document to be written. For example, in the screen embodiment illustrated in FIG. 9, default prompt chips are exposed and displayed as “Inquiry,” “Answer,” “Accept and Review,” “Reject,” and “Suggest Alternative.”

The “Best Prompt” at the bottom of FIG. 9 refers to a rank-based recommended prompt, and “Generate Again” is selected, another rank-based recommended prompt may be generated and provided.

a Device to which the Proposed Method of the Present Disclosure can be Applied

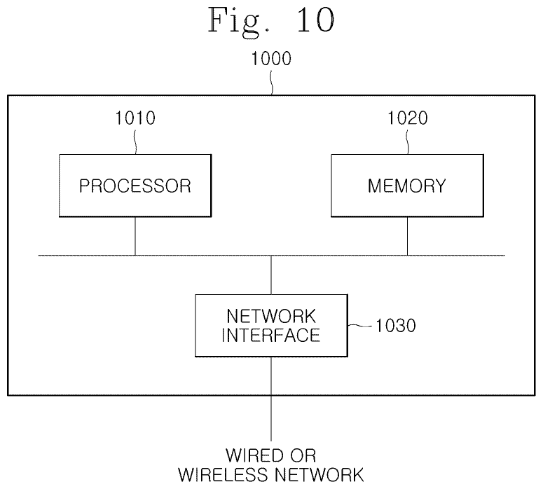

FIG. 10 illustrates a device 1000 to which the proposed method of the present disclosure can be applied. The device 1000 may be a server or a terminal which provides a prompt for generative AI-based document writing.

Referring to FIG. 10, the device 1000 may be a server device or a terminal device configured to implement a process for a method for providing a prompt for generative AI-based document writing.

For example, the device 1000 to which the proposed method of the present disclosure can be applied may include a network device such as a repeater, a hub, a bridge, a switch, a router, or a gateway, a computer device such as a desktop computer or a workstation, a mobile terminal such as a smartphone, a portable device such as a laptop computer, house electric appliances such as digital televisions, a movement means such as an automobile, and the like. In another example, the device 1000 to which the present disclosure can be applied may be included as part of an application specific integrated circuit (ASIC) implemented in the form of a system on chip (SoC).

A memory 1020 may be operatively connected to a processor 1010, may store programs and/or instructions for processing or control of the processor 1010, and may store data and information used in the present disclosure, control information required for processing the data and the information according to the present disclosure, temporary data generated during processing of the data and the information, and the like. The memory 1020 may be implemented as a storage device such as read-only memory (ROM), random-access memory (RAM), erasable programmable read-only memory (EPROM), electrically erasable programmable read-only memory (EEPROM), flash memory, static RAM (SRAM), a hard disk drive (HDD), a solid-state drive (SSD), or the like.

The processor 1010 may be operatively connected to the memory 1020 and a network interface 1030, and controls the operation of each module within the device 1000. In particular, the processor 1010 may perform various control functions for performing the proposed method of the present disclosure. The processor 1010 may also be referred to as a controller, a microcontroller, a microprocessor, a microcomputer, etc. The proposed method of the present disclosure may be implemented using hardware, firmware, software, or a combination thereof. When the present disclosure is implemented using hardware, the processor 1010 may include an application specific integrated circuit (ASIC), a digital signal processor (DSP), a digital signal processing device (DSPD), a programmable logic device (PLD), a field programmable gate array (FPGA), or the like configured to perform the present disclosure. Meanwhile, when the proposed method of the present disclosure is implemented using firmware or software, the firmware or the software may include instructions that are related to a module, a procedure, or a function for performing functions or operations necessary for implementing the proposed method of the present disclosure. The instructions may be stored in the memory 1020 or on a computer-readable recording medium (not shown) separate from the memory 1020. The instructions may be configured to, when executed by the processor 1010, cause the device 1000 to implement the proposed method of the present disclosure.

Furthermore, the device 1000 may include the network interface device 1030. The network interface device 1030 may be operatively connected to the processor 1010, and the processor 1010 may control the network interface device 1030 to transmit or receive wireless/wired signals carrying information and/or data, signals, messages, etc. over a wireless/wired network. The network interface device 1030 may support various communication standards, such as IEEE 802 series, 3GPP LTE(-A), and 3GPP 5G, and may transmit and receive control information and/or data signals in accordance with the communication standards. The network interface device 1030 may also be implemented outside the device 1000 as needed.

The above embodiments and drawings described in the present specification are merely illustrative and do not limit the scope of the present disclosure in any way. Furthermore, connection members or connections of lines components shown in the drawings are merely illustrative of functional connections and/or physical or circuit connections, and may be represented by alternative or additional various functional connections, physical connections, or circuit connections in an actual device. Furthermore, unless specifically mentioned as “essential”, “important,” etc., the components may not be necessarily required for the application of the present disclosure.

In the specification (particularly, in the claims) of the present disclosure, the use of the term “the” and similar indicative terms may be applied to both singular and plural forms. Furthermore, when a range is described in the present disclosure, it is understood that the present disclosure includes embodiments that employ individual values within the range (unless otherwise specified), and this is equivalent to describing each individual value constituting the range in the detailed description of the disclosure. Furthermore, the operations presented in the method of the present disclosure are not intended to impose any restrictions on the order of execution thereof, and the order may be appropriately changed as needed, unless the nature of each process requires that a specific operation necessarily precedes another operation. In the present disclosure, the use of any examples or exemplary terms (e.g., etc.) is merely for the purpose of describing the present disclosure in detail, and unless limited by the claims, the scope of the disclosure is not limited by such examples or exemplary terms. Furthermore, it will be understood by those skilled in the art that various modifications, combinations, and changes may be made based on design conditions and elements within the appended claims or equivalents thereof.

What is claimed is:

1. A method for providing a prompt for generative AI-based document writing, the method comprising:
receiving a command to execute a document writing application;
determining a prompt to be provided from among a static prompt and a dynamic prompt;
displaying, on a screen, the prompt to be provided; and
in case that the prompt to be provided is selected, receiving a document, generated based on the prompt to be provided, from an LLM.

2. The method of claim 1, further comprising in case that the static prompt is determined as the prompt to be provided in the determining of the prompt to be provided,
checking whether there is a configuration for the static prompt, exposing a configured prompt chip on the screen in case that there is a configuration, and exposing a default prompt chip on the screen in case that there is no configuration.

3. The method of claim 1, further comprising
determining whether to add personal content information to the static prompt, in case that the static prompt is determined as the prompt to be provided in the determining of the prompt to be provided.

4. The method of claim 1, wherein in case that the dynamic prompt is determined as the prompt to be provided in the determining of the prompt to be provided, at least one of an AI-based recommended prompt and a rank-based recommended prompt is displayed on the screen in the displaying of the prompt to be provided on the screen.

5. The method of claim 4, wherein the AI-based recommended prompt is generated based on at least one of content information and a prompt call history of a user of the document writing application.

6. The method of claim 4, wherein the rank-based recommended prompt is generated based on information comprising the prompt call history of the user of the document writing application.

7. The method of claim 4, further comprising:
checking whether a prompt category selection for the dynamic prompt is input;
exposing and displaying only at least one selected prompt category in case that the prompt category selection is input; and
exposing and displaying all prompt categories in case that the prompt category selection is not input.

8. The method of claim 1, wherein in case that the prompt to be provided is selected, information about the prompt to be provided is stored as prompt history information.

9. The method of claim 8, wherein the prompt history information is used when generating an AI-based recommended prompt or a rank-based recommended prompt.

10. A computer program stored on a medium in order to perform, in combination with hardware, the method for providing a prompt for generative AI-based document writing according to claim 1.

11. A device for providing a prompt for generative AI-based document writing, the device comprising a processor,
wherein the processor is configured to perform:
receiving a command to execute a document writing application;
determining a prompt to be provided from among a static prompt and a dynamic prompt;
displaying, on a screen, the prompt to be provided; and
in case that the prompt to be provided is selected, receiving a document, generated based on the prompt to be provided, from an LLM.

12. The device of claim 11, wherein the processor is configured to further perform,
in case that the static prompt is determined as the prompt to be provided in the determining of the prompt to be provided,
checking whether there is a configuration for the static prompt, exposing a configured prompt chip on the screen in case that there is a configuration, and exposing a default prompt chip on the screen in case that there is no configuration.

13. The device of claim 11, wherein the processor is configured to further perform
determining whether to add personal content information to the static prompt, in case that the static prompt is determined as the prompt to be provided in the determining of the prompt to be provided.

14. The device of claim 11, wherein in case that the dynamic prompt is determined as the prompt to be provided in the determining of the prompt to be provided, at least one of an AI-based recommended prompt and a rank-based recommended prompt is displayed on the screen in the displaying of the prompt to be provided on the screen.

15. The device of claim 14, wherein the AI-based recommended prompt is generated based on at least one of content information and a prompt call history of a user of the document writing application.

16. The device of claim 14, wherein the rank-based recommended prompt is generated based on information comprising the prompt call history of the user of the document writing application.

17. The device of claim 14, wherein the processor is configured to further perform:
checking whether a prompt category selection for the dynamic prompt is input;
exposing and displaying only at least one selected prompt category in case that the prompt category selection is input; and
exposing and displaying all prompt categories in case that the prompt category selection is not input.

18. The device of claim 11, wherein in case that the prompt to be provided is selected, information about the prompt to be provided is stored as prompt history information.

19. The device of claim 18, wherein the prompt history information is used when generating an AI-based recommended prompt or a rank-based recommended prompt.
